(19) United States
(12) Patent Application Publication
(10) Pub. No.: US 2013/0332964 A1
(43) Pub. Date: Dec. 12, 2013

(54) EXPOSING SORTED DATA USING AN EXPANDED CONTENT HIERARCHY

(71) Applicant: Mohammad Bassam Afaneh, Noblesville, IN (US)

(72) Inventor: Mohammad Bassam Afaneh, Noblesville, IN (US)

(73) Assignee: THOMSON LICENSING, Issy les Moulineaux (FR)

(21) Appl. No.: 13/981,179

(22) PCT Filed: Nov. 30, 2011
(86) PCT No.: PCT/US11/62506

§ 371 Date: Jul. 23, 2013

Related U.S. Application Data
(60) Provisional application No. 61/429,835, filed on Jan. 5, 2011.

(51) Int. Cl. H04N 21/482

(52) U.S. Cl. CPC H04N 21/482
USPC 725/53

(57) ABSTRACT

A method and apparatus for sorting data include sub-categorizing sorted data using defined sub-categories of a digital live network alliance hierarchy and enabling a search of the sub-categorized sorted data using the defined sub-categories of the digital live network alliance hierarchy. The sorting of the present invention enables a search to be performed which requires reduced filtering processes to be performed by a requesting client to achieve a desired search result and reduced bandwidth for communicating a result of a search to a requesting client as compared with non sub-categorized sorted data. In one instance, universal plug and play attributes are used to search the sub-categorized sorted data.

### FIELD OF THE INVENTION

The present invention generally relates to accessing sorted data, such as Electronic Program Guide (EPG) data and, more particularly, to a method and apparatus for exposing sorted data using an expanded content hierarchy.

### BACKGROUND OF THE INVENTION

Content can be stored on any number of different devices and arranged using various different sorting methods. Typically in Digital Live Network Alliance (DLNA), a Content Directory Service comprises a list of individual items (e.g., songs, movies, list of TV shows currently being broadcast . . . etc). Typically, these items have associated attributes/properties that are defined by DLNA (i.e., for a TV show, the channel name is an attribute). Currently, if a client wants to look for TV programs that start in a specific range of time (e.g. 8-9 am), they would have to query for all items and then filter them at their side. Such a process for looking up content is very inefficient.

### SUMMARY OF THE INVENTION

Embodiments of the present invention address the deficiencies of the prior art by providing a method and apparatus for exposing sorted data using an expanded content hierarchy compatible with the DLNA Content Directory Service (CDS) hierarchy to provide any DLNA compliant client access to specific data sorted hierarchically using different criteria. That is, embodiments of the invention provide a means and device for DLNA-compliant clients to browse, navigate and query CDS items that are of specific interest based on grouping by specific attributes.

In one embodiment of the present invention, a method for sorting data includes sub-categorizing sorted data using defined sub-categories of a digital live network alliance hierarchy and enabling a search of the sub-categorized sorted data using the defined sub-categories of the digital live network alliance hierarchy such that reduced filtering processes are required to be performed by a requesting client to achieve a desired search result and a result of the search requires reduced bandwidth for communicating a result of a search to a requesting client as compared with non- sub-categorized sorted data.

In an alternate embodiment of the present invention, an apparatus for sorting data includes a memory for storing program routines and data and a processor for executing the program routines. The processor of the apparatus, when executing the program routines, is configured to perform the steps of sub-categorizing sorted data using defined sub-categories of a digital live network alliance hierarchy and enabling a search of said sub-categorized sorted data using the defined sub-categories of said digital live network alliance hierarchy such that reduced filtering processes are required to be performed by a requesting client to achieve a desired search result and a result of said search requires reduced bandwidth for communicating a result of a search to a requesting client as compared with non-sub-categorized sorted data.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a prior art standard Universal Plug and Play (UPnP)/DLNA content hierarchy;

FIG. 2 depicts a high level block diagram of an expanded content hierarchy in accordance with an embodiment of the present invention; and

FIG. 3 depicts a high level block diagram of a device for exposing sorted data using an expanded content hierarchy in accordance with an alternate embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method and apparatus for exposing sorted data using a Digital Live Network Alliance (DLNA) hierarchy. Although the present invention will be described primarily within the context of sorted data existing in an Electronic Program Guide, the specific embodiments of the present invention should not be treated as limiting the scope of the invention. It will be appreciated by those skilled in the art and informed by the teachings of the present invention that the concepts of the present invention can be advantageously applied to other types of sorted data. For example, the concepts of the present invention can be applied to a listing of video items grouped under categories of low, medium and high bit-rate video files under a hierarchy that groups items by file size ranges. A general concept of various embodiment of the present invention includes the grouping and filtering of data given a property or property range criterion.

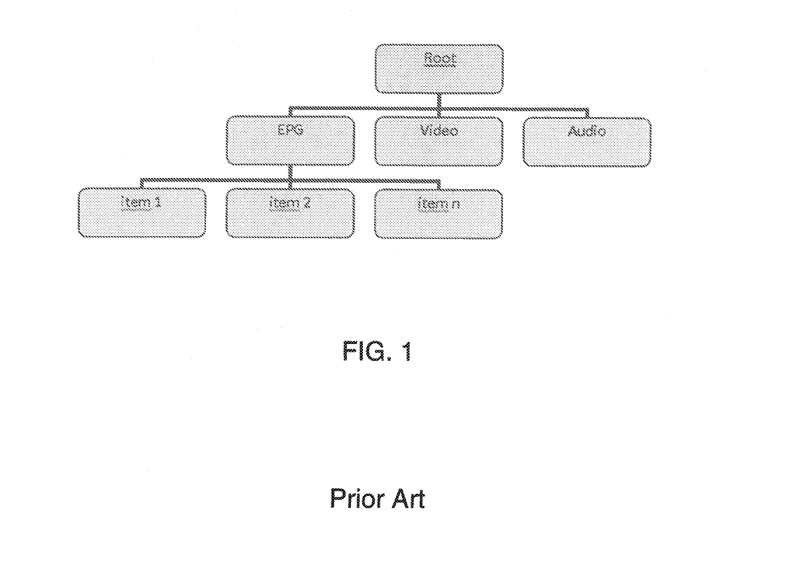

FIG. 1 depicts a high level block diagram of a prior art standard Universal Plug and Play (UPnP)/DLNA content hierarchy. As depicted in FIG. 1, the standard UPnP/DLNA content hierarchy includes a root directory under which is sorted electronic program guide (EPG) data, Video data and audio data.

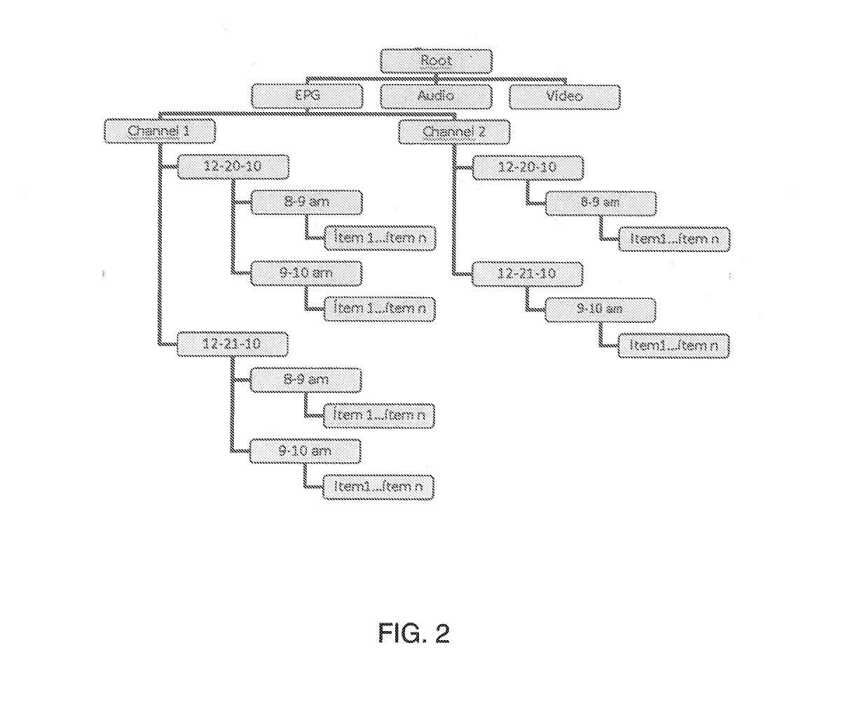

FIG. 2 depicts a high level block diagram of an expanded content hierarchy in accordance with an embodiment of the present invention. That is, in the embodiment of the present invention of FIG. 2, an expanded content hierarchy compatible with the DLNA Content Directory Service (CDS) hierarchy of FIG. 1 is provided to enable any DLNA compliant client access to specific data sorted hierarchically using predetermined sorting criteria. That is, in the embodiment of the present invention of FIG. 2, content hierarchy is expanded to create additional level(s) for grouping data based on attributed properties. For example and as depicted in FIG. 2, for TV shows listed in an EPG, the expanded hierarchy of the present invention includes three additional sorting levels: one level for TV shows separated by channel (Channel 1, Channel 2 . . . etc), another level for date of show presentation (including the day of week), and a third level for time ranges of broadcast start time. Using such sorting in accordance with the described embodiment of the present invention, enables a client to obtain a list of programs that start between 8-9 am on Monday Dec. 21, 2010 on Channel 2 by browsing through the hierarchy Channel 2 Dec. 21, 2010 8-9 am.

In accordance with various embodiments of the present invention, the sorting of the present invention is performed on the Content Directory Service side of the process. As such and because the sorting is performed on the Content Directory Service side, advantages of the present invention include at least:
Saving a client (Control Point) from performing additional filtering processes each time a client wants to search sorted data.
Giving a client access to the data of interest while reducing bandwidth that would have been otherwise used to retrieve items for which the client had no interest.

That is, the expanded hierarchy of the present invention enables a client to more specifically search for content or data thus retrieving only content or data for which a client expresses interest instead of receiving a larger amount of content/data in which the client's content/data of interest is buried.

Embodiments of the present invention utilize the attributes that describe the different types of items in the CDS. For example, EPG items have the attributes upnp:scheduledStartTime and upnp:scheduledEndTime which can be used for determining the date and time-range in which an item of interest (e.g. TV program) lies. In addition, defined properties such as upnp:channelNr and upnp:channelName are implemented in accordance with the concepts of the present invention for the grouping, for example, TV programs per broadcast channel.

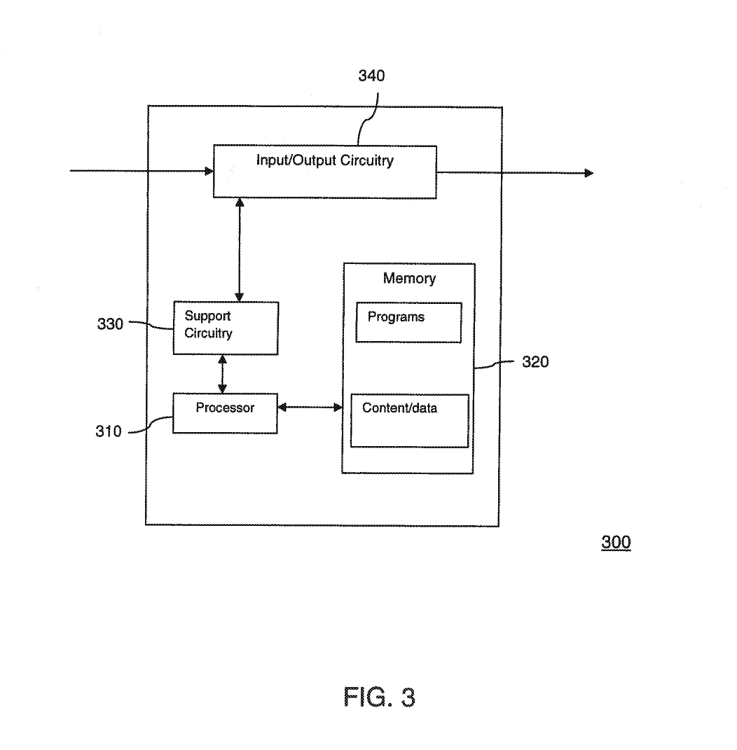

FIG. 3 depicts a high level block diagram of a device 300 for exposing sorted data using an expanded content hierarchy in accordance with an embodiment of the present invention. More specifically, the device 300 of FIG. 3 illustratively comprises a processor 310 as well as a memory 320 for storing control programs, file information, stored media and the like. The device 300 cooperates with conventional support circuitry 330 such as power supplies, clock circuits, cache memory and the like as well as circuits that assist in executing the software routines stored in the memory 320. As such, it is contemplated that some of the process steps discussed herein as software processes may be implemented within hardware, for example, as circuitry that cooperates with the virtual network manager 110 to perform various steps. The device 300 also contains input-output circuitry 340 that forms an interface between various functional elements communicating with the device 300.

Again, although the device 300 of FIG. 3 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software, hardware, or a combination thereof. In addition, although the device 300 of FIG. 3 is depicted as a separate component, the functionalities of the device 300 in accordance with the concepts and embodiments of the present invention described herein can be incorporated into an existing content management system component such as a set-top box, personal video recorder, digital video recorder or content provider server and the like.

Having described various embodiments for a method and apparatus for exposing sorted data using a Digital Live Network Alliance (DLNA) hierarchy (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method for sorting data, comprising:
sub-categorizing sorted data using defined sub-categories of a digital live network alliance hierarchy; and
enabling a search of said sub-categorized sorted data using the defined sub-categories of said digital live network alliance hierarchy such that reduced filtering processes are required to be performed by a requesting client to achieve a desired search result and a result of said search requires reduced bandwidth for communicating a result of a search to a requesting client as compared with non-sub-categorized sorted data.

2. The method of claim 1, wherein sub-categories include low, medium and high bit-rate video data files.

3. The method of claim 1, wherein said sorted data comprises electronic program guide data.

4. The method of claim 1, wherein said sub-categorizing is performed at a content directory service side.

5. The method of claim 1, wherein at least one universal plug and play attribute is used to search said sub-categorized sorted data.

6. An apparatus for sorting data, comprising:
a memory for storing program routines and data; and
a processor for executing said program routines, said processor, when executing said program routines, configured to perform the steps of:
sub-categorizing sorted data using defined sub-categories of a digital live network alliance hierarchy; and
enabling a search of said sub-categorized sorted data using the defined sub-categories of said digital live network alliance hierarchy such that reduced filtering processes are required to be performed by a requesting client to achieve a desired search result and a result of said search requires reduced bandwidth for communicating a result of a search to a requesting client as compared with non-sub-categorized sorted data.

7. The apparatus of claim 6, wherein said apparatus comprises a set-top box.

8. The apparatus of claim 7, wherein said apparatus comprises a personal video recorder.

9. The apparatus of claim 7, wherein said apparatus comprises a digital video recorder.

10. The apparatus of claim 7, wherein said apparatus comprises a content provider server.
